(19) United States
(12) Patent Application Publication
(10) Pub. No.: US 2008/0224974 A1
(43) Pub. Date: Sep. 18, 2008

(54) Liquid crystal display

(76) Inventor: Leonard Tsai, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/725,098

(22) Filed: Mar. 16, 2007

(51) Int. Cl. G09G 3/36

(52) U.S. Cl. 345/88

(57) ABSTRACT

In one embodiment, a display device, comprises a liquid crystal module, a backlight assembly comprising an array of red light emitting diodes, an array of green light emitting diodes, and an array of green light emitting diodes, and a timing controller to drive the array of red light emitting diodes, the array of green light emitting diodes, and the array of green light emitting diodes in successive illumination cycles, wherein the timing controller inserts a black frame cycle between each illumination cycle.

### BACKGROUND

Many electronic devices include color liquid crystal displays (LCDs). Some LCDs utilize a white backlight, which is passed through at least one color filter to make different colors available to the LCD screen. Pixels on the LCD screen are assigned to groups of three, which include a red pixel, a green pixel, and a blue pixel. By managing the intensity of the red, green, and blue pixels, colors are presented on the screen.

The color filters required for such LCD assemblies add to the cost, size, and complexity of the LCD assemblies. Further, assigning pixels into groups of three reduces the resolution of the LCD display. Thus, improved LCD assemblies may find utility.

### BRIEF DESCRIPTION OF THE DRAWINGS

FIG. 1A is a schematic, front view of a LCD assembly, according to an embodiment.

FIG. 1B is an exploded, side view of a LCD assembly, according to an embodiment.

FIGS. 2A and 2B are schematic illustrations of a display timing sequence, according to embodiments.

FIG. 3 is a schematic illustration of a computing system, according to an embodiment.

### DETAILED DESCRIPTION

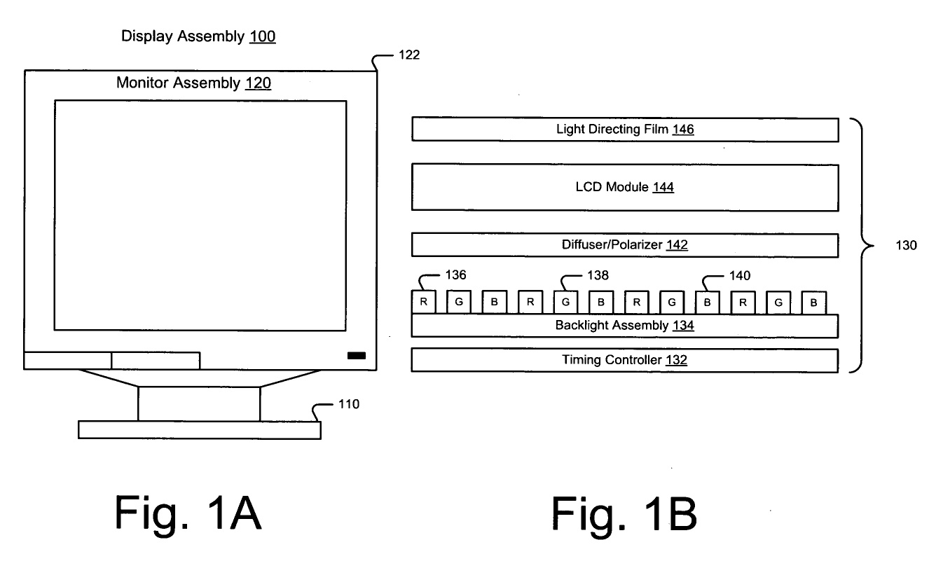

FIG. 1A is a schematic, front view of a LCD assembly, according to an embodiment, and FIG. 1B is an exploded, side view of a LCD assembly, according to an embodiment. Referring to FIG. 1A, a display assembly 100 comprises a base 110 and a monitor assembly 120 coupled to the base. Monitor assembly 120 comprises a housing 122, which houses a LCD assembly 130.

Referring to FIG. 1B, LCD assembly 130 comprises a timing controller 132, a backlight assembly 134, a diffuser 142, a LCD module 144, and a light directing film 146. Display assembly 100 may be embodied as any type of color graphics display. In one embodiment, LCD module 144 may comprise a thin film transistor (TFT) assembly. In other embodiments, the LCD module 144 may embodied as a different type of LCD, e.g., a diode matrix or another capacitively driven LCD, a digital mirror assembly, or the like.

Backlight assembly 134 comprises arrays of light emitting diodes (LEDs) including, e.g., an array of red LEDs 136, an array of green LEDs 138, and an array of blue LEDs 140. A diffuser 142 is positioned adjacent the backlight assembly 134. In some embodiments, diffuser 142 may also act as a polarizer to polarize light emitted by the arrays of LEDs 136, 138, 140.

A LCD module 144 is positioned adjacent diffuser 142. In some embodiments, LCD module may be a twisted nematic LCD, an In-plane switching LCD, or a vertical alignment (VA) LCD. In some embodiments, a light directing film 146 may be positioned adjacent the LCD to enhance the brightness of the display.

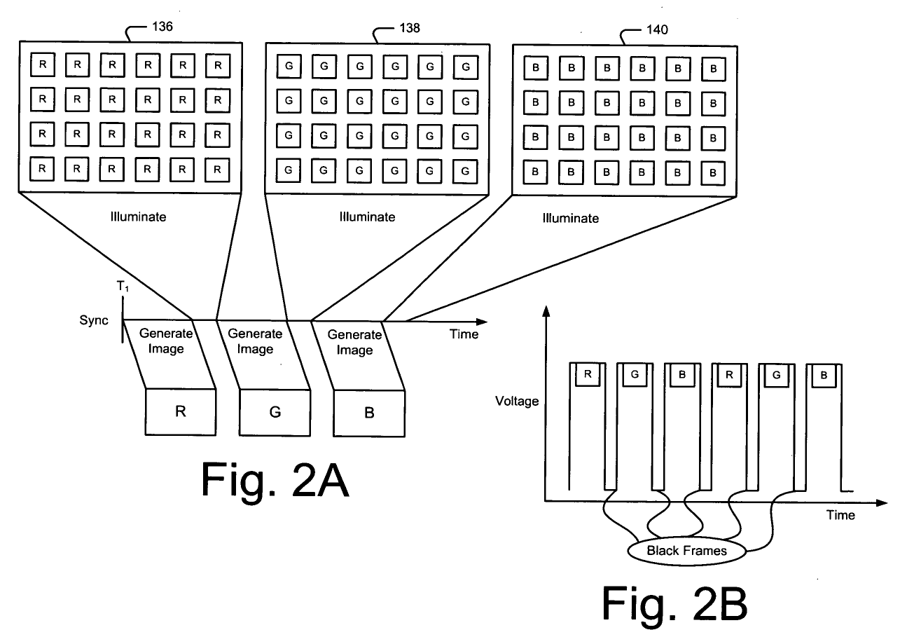

In some embodiments, the LED arrays 136, 138, 140 may be illuminated in sequence to create a color image on LCD assembly 130. FIGS. 2A and 2B are schematic illustrations of a display timing sequence, according to embodiments. The timing sequence may be managed by the timing controller 132.

FIG. 2A illustrates a timing sequence for the presentation of a single color image on the LCD assembly 130. In the embodiment depicted in FIG. 2A, the timing controller implements a multi-step process to display a full-color image on the LCD assembly 130. The multi-step process successively generates a single color component image of a full-color image, then illuminates the screen with the color component. This process is repeated with each color component of a full-color image. When implemented at a sufficiently fast cycle rate, the successive single color component images appear as a full-color image.

Referring to FIG. 2A, initially the LCD assembly is synchronized at time T₁. A red component of a full-color image is generated on LCD assembly 130, and then the array of red LEDs 136 is illuminated. A green component of a full-color image is generated on LCD assembly 130, and then the array of green LEDs 138 is illuminated. Finally, a blue component of a full-color image is generated on LCD assembly 130, and then the array of blue LEDs 140 is illuminated. The combination of the red, green, and blue images generate a full color image on display assembly 130.

Many display assemblies operate using a 60 Hz image refresh rate. In some embodiments the timing controller 132 operates such that each refresh cycle is subdivided into (n+1) different cycles, where n corresponds to the number of component color images presented on the display assembly 130. For example, in an embodiment which uses red, green, and blue LEDs, the 60 Hz refresh rate may be divided into four different cycles. In some embodiments a white illumination cycle may be added to the backlight assembly, (e.g., by the addition of a white LED array or by the contemporaneous illumination of the red, green, and blue LED arrays) to increase the luminance of the screen, such that each refresh cycle is subdivided into five different cycles.

FIG. 2B illustrates the timing cycle of timing controller 132 in an embodiment that utilizes a three-cycle illumination scheme. Referring to FIG. 2B, after the initial synchronization period, a voltage is applied to the array of red LEDs 136, the voltage is maintained for a time period of approximately ( 1/240) second, then the voltage is removed from array of red LEDs 136. A delay of approximately ( 1/720) second is introduced before a voltage is applied to the array of green LEDs 138. The voltage is maintained for a time period of approximately ( 1/240) second, then the voltage is removed from array of green LEDs 138. Another delay of approximately ( 1/720) second is introduced before a voltage is applied to the array of blue LEDs 140. The voltage is maintained for a time period of approximately ( 1/240) second, then the voltage is removed from array of blue LEDs 140. Another delay of approximately ( 1/720) second is introduced before a voltage is applied to the array of red LEDs 136, and the cycle continues.

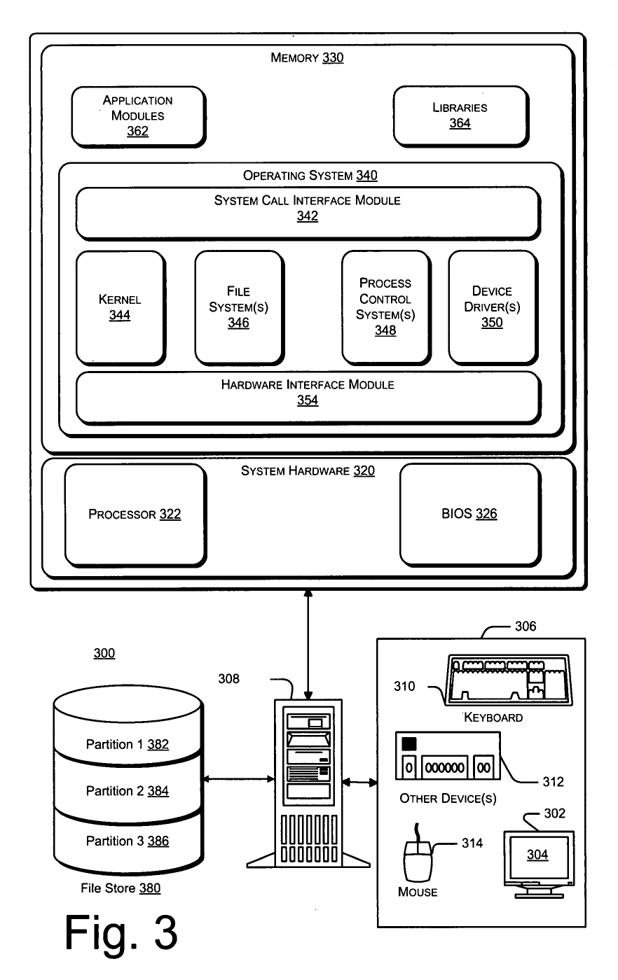

In another embodiment, a display assembly may be distributed as a component of a computer system. FIG. 3 is a schematic illustration of a computing system, according to an embodiment. The components shown in FIG. 3 are only examples, and are not intended to suggest any limitation as to the scope of the functionality of the invention; the invention is not necessarily dependent on the features shown in FIG. 3. In the illustrated embodiment, computer system 300 may be embodied as a hand-held or stationary device for accessing the Internet, a desktop PCs, notebook computer, personal digital assistant, or any other processing devices that have a basic input/output system (BIOS) or equivalent.

The computing system 300 includes a computer 308 and one or more accompanying input/output devices 306 including a display 302 having a screen 304, a keyboard 310, other I/O device(s) 312, and a mouse 314. The other device(s) 312 may include, for example, a touch screen, a voice-activated input device, a track ball, and any other device that allows the system 300 to receive input from a developer and/or a user.

The computer 308 includes system hardware 320 commonly implemented on a motherboard and at least one auxiliary circuit boards. System hardware 320 including a processor 322 and a basic input/output system (BIOS) 326. BIOS 326 may be implemented in flash memory and may comprise logic operations to boot the computer device and a power-on self-test (POST) module for performing system initialization and tests. In operation, when activation of computing system 300 begins processor 322 accesses BIOS 326 and shadows the instructions of BIOS 326, such as power-on self-test module, into operating memory. Processor 322 then executes power-on self-test operations to implement POST processing.

Computer system 300 further includes a file store 380 communicatively connected to computer 308. File store 380 may be internal such as, e.g., one or more hard drives, or external such as, e.g., one or more external hard drives, network attached storage, or a separate storage network. In some embodiments, the file store 380 may include one or more partitions 382, 384, 386.

Memory 330 includes an operating system 340 for managing operations of computer 308. In one embodiment, operating system 340 includes a hardware interface module 354 that provides an interface to system hardware 320. In addition, operating system 340 includes a kernel 344, one or more file systems 346 that manage files used in the operation of computer 308 and a process control subsystem 348 that manages processes executing on computer 308. Operating system 340 further includes one or more device drivers 350 and a system call interface module 342 that provides an interface between the operating system 340 and one or more application modules 362 and/or libraries 364. The various device drivers 350 interface with and generally control the hardware installed in the computing system 300.

In operation, one or more application modules 362 and/or libraries 364 executing on computer 308 make calls to the system call interface module 342 to execute one or more commands on the computer's processor. The system call interface module 342 invokes the services of the file systems 346 to manage the files required by the command(s) and the process control subsystem 348 to manage the process required by the command(s). The file system(s) 346 and the process control subsystem 348, in turn, invoke the services of the hardware interface module 354 to interface with the system hardware 320. The operating system kernel 344 can be generally considered as one or more software modules that are responsible for performing many operating system functions.

The particular embodiment of operating system 340 is not critical to the subject matter described herein. Operating system 340 may be embodied as a UNIX operating system or any derivative thereof (e.g., Linux, Solaris, etc.) or as a Windows® brand operating system or another operating system.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A display device, comprising:
a liquid crystal module;
a backlight assembly comprising an array of red light emitting diodes, an array of green light emitting diodes, and an array of blue light emitting diodes; and
a timing controller to drive the array of red light emitting diodes, the array of green light emitting diodes, and the array of blue light emitting diodes in successive illumination cycles, wherein the timing controller inserts a black frame cycle between each illumination cycle.

2. The display device of claim 1, further comprising a diffuser interposed between the backlight assembly and the liquid crystal module.

3. The display device of claim 1, wherein:
a red component image is generated on the liquid crystal module before the array of red light emitting diodes is illuminated;
a green component image is generated on the liquid crystal module before the array of green light emitting diodes is illuminated; and
a blue component image is generated on the liquid crystal module before the array of blue light emitting diodes is illuminated.

4. The display device of claim 1, further comprising a light directing film adjacent the liquid crystal module.

5. The display device of claim 1, wherein:
the timing controller activates the array of red light emitting diodes, the array of green light emitting diodes, and the array of blue light emitting diodes in successive illumination cycles of a first duration; and
the black frame cycle measures approximately one-third the first duration.

6. The display device of claim 1, wherein the backlight assembly further comprises an array of white light emitting diodes, and wherein the timing controller drives the an illumination cycle for the white light emitting diodes.

7. The display device of claim 1, wherein the timing controller operates at a refresh rate of 60 Hz, and wherein each LED array is active for a fraction of each refresh cycle.

8. A display assembly, comprising:
a base;
a monitor assembly coupled to the base and comprising:
a liquid crystal module;
a backlight assembly comprising an array of red light emitting diodes, an array of green light emitting diodes, and an array of green light emitting diodes; and
a timing controller to drive the array of red light emitting diodes, the array of green light emitting diodes, and the array of blue light emitting diodes in successive illumination cycles, wherein the timing controller inserts a black frame cycle between each illumination cycle.

9. The display assembly of claim 8, further comprising a diffuser interposed between the backlight assembly and the liquid crystal module.

10. The display assembly of claim 8, wherein:
a red component image is generated on the liquid crystal module before the array of red light emitting diodes is illuminated;
a green component image is generated on the liquid crystal module before the array of green light emitting diodes is illuminated; and
a blue component image is generated on the liquid crystal module before the array of blue light emitting diodes is illuminated.

11. The display assembly of claim 8, further comprising a light directing film adjacent the liquid crystal module.

12. The display assembly of claim 8, wherein:
the timing controller activates the array of red light emitting diodes, the array of green light emitting diodes, and the array of blue light emitting diodes in successive illumination cycles of a first duration; and
the black frame cycle measures approximately one-third the first duration.

13. The display assembly of claim 8, wherein the backlight assembly further comprises an array of white light emitting diodes, and wherein the timing controller drives the an illumination cycle for the white light emitting diodes.

14. The display assembly of claim 8, wherein the timing controller operates at a refresh rate of 60 Hz, and wherein each LED array is active for a fraction of each refresh cycle.

15. A computing device, comprising:
a processor; and
display device, comprising:
a liquid crystal module;
a backlight assembly comprising an array of red light emitting diodes, an array of green light emitting diodes, and an array of green light emitting diodes; and
a timing controller to drive the array of red light emitting diodes, the array of green light emitting diodes, and the array of blue light emitting diodes in successive illumination cycles, wherein the timing controller inserts a black frame cycle between each illumination cycle.

16. The computing device of claim 15, further comprising a diffuser interposed between the backlight assembly and the liquid crystal module.

17. The computing device of claim 15, wherein:
a red component image is generated on the liquid crystal module before the array of red light emitting diodes is illuminated;
a green component image is generated on the liquid crystal module before the array of green light emitting diodes is illuminated; and
a blue component image is generated on the liquid crystal module before the array of blue light emitting diodes is illuminated.

18. The computing device of claim 15, further comprising a light directing film adjacent the liquid crystal module.

19. The computing device of claim 15, wherein:
the timing controller activates the array of red light emitting diodes, the array of green light emitting diodes, and the array of blue light emitting diodes in successive illumination cycles of a first duration; and
the black frame cycle measures approximately one-third the first duration.

20. The computing device of claim 15, wherein the backlight assembly further comprises an array of white light emitting diodes, and wherein the timing controller drives the an illumination cycle for the white light emitting diodes.
